(19) United States
(12) Patent Application Publication
(10) Pub. No.: US 2003/0109627 A1
(43) Pub. Date: Jun. 12, 2003

(54) Aqueous coating agents for baking enamels with a high solid content

(76) Inventors: Beate Baumbach, Leverkusen (DE); Christian Wamprecht, Neuss (DE); Heino Muller, Leverkusen (DE); Joachim Petzoldt, Monheim (DE)

Correspondence Address: BAYER CORPORATION, PATENT DEPARTMENT, 100 BAYER ROAD, PITTSBURGH, PA, 15205, US

(21) Appl. No.: 10/204,951

(22) PCT Filed: Feb. 15, 2001
(86) PCT No.: PCT/EP01/01651

(30) Foreign Application Priority Data
Feb. 28, 2000 (DE) 100 09 414.7
Feb. 28, 2000 (DE) 100 09 412.0
Feb. 28, 2000 (DE) 100 09 413.9

(51) Int. Cl. C08K 3/00

(52) U.S. Cl. 524/507; 524/589

(57) ABSTRACT

The invention relates to novel, aqueous coating agents for baking enamels, in particular for producing hard, elastic fillers with a high solid content for coating metals, plastics, wood and glass.

The present invention relates to novel aqueous coating compositions for stoving lacquerings, in particular for the production of hard, elastic, high-solids filler compositions with very good protection against flying stones, and the use thereof for coating metals, plastics, wood and glass.

The importance of aqueous lacquers and coatings has risen sharply in recent years because of ever stricter emission guidelines in respect of the solvents released during application of the lacquer. Although aqueous lacquer systems have since already been available for many fields of use, these often cannot yet completely achieve the high quality level of conventional solvent-containing lacquers in respect of resistance to solvents and chemicals or also elasticity and resistance to mechanical stresses. In particular, no polyurethane-based coating compositions which are to be processed from the aqueous phase and completely meet the high requirements in practice of hard but at the same time elastic filler compositions of high solids content for coating car bodies in respect of film hardness, impact strength, resistance to flying stones and resistance to water and chemicals are as yet known.

This observation applies both to GB-A 1 444 933, EP-A 0 061 628 and DE-A 2 359 613, which are concerned with hydrophilic modification of aromatic polyisocyanates, and to DE-A 4 001 783, which is concerned with specific anionically modified aliphatic polyisocyanates, as well as to the systems of DE-A 2 456 469, DE-A 2 814 815, EP-A 0 012 348 and EP-A 0 424 697, which are concerned with aqueous stoving binders based on blocked polyisocyanates and organic polyhydroxy compounds. The systems based on polyurethane prepolymers which contain carboxyl groups and have masked isocyanate groups, according to DE-A 2 708 611, and the blocked water-soluble urethane prepolymers according to DE-A 3 234 590 are also largely unusable for the field of use mentioned. Significant advances in respect of elasticity and resistance to solvents, water and chemicals are to be achieved with the systems of DE-A 4 221 924, which describes combinations of specific blocked water-soluble or -dispersible polyisocyanate mixtures and specific water-soluble or -dispersible polyhydroxy compounds. Further improvements in respect of the required stoving temperature and reactivity of stoving lacquers can be achieved if water-dilutable or water-dispersible polyisocyanate crosslinking agents are used with pyrazoles as blocking agents, as described e.g. in WO 97/12924 and EP-A 0 802 210.

The solids content, including binders, crosslinking agents, additives, pigments and fillers, of these aqueous filler compositions described, some of which are in use in practice, is in general between 47 and 50, and a maximum of 53 wt. %, at the processing viscosity. However, a substantially higher solids content is desirable in this connection, in order to significantly improve the application efficiency during use. A substantially higher hardness is furthermore required for a better sandability of the filler compositions, where good elasticity properties should simultaneously guarantee a high level of protection against flying stones.

As has now been found, surprisingly, the preparation of stoving filler compositions which are to be processed from the aqueous phase and, in addition to the requirements met by filler compositions in practice to date, have a higher solids content and give, after stoving, coatings of very high hardness but at the same time very good protection properties against flying stones is possible if selected combinations of the type described below in more detail are used as binders. The stoving lacquers according to the invention comprise:

I) specific blocked polyisocyanates dispersed in water,

II) water-soluble or -dispersible polyhydroxy compounds,

III) optionally water-soluble or -dispersible crosslinking resins and

IV) optionally further water-soluble or -dispersible substances.

Very high solids contents can be achieved by using these new binder mixtures according to the invention in aqueous stoving lacquers. There is therefore an increase in the application efficiency and the yield. In filler composition applications, coatings in which the hardness and therefore also the sandability as well as the top lacquer status are significantly improved compared with the prior art are obtained.

The invention relates to binder mixtures for aqueous stoving lacquers, comprising:

I) specific blocked polyisocyanates dispersed in water,

II) water-soluble or -dispersible polyhydroxy compounds,

III) optionally water-soluble or -dispersible crosslinking resins and

IV) optionally further water-soluble or -dispersible substances,

characterized in that component I) comprises

A) 40 to 80 wt. % of one or more polyisocyanate components,

B) 10 to 40 wt. % of one or more blocking agents for isocyanate groups which are monofunctional in the sense of the isocyanate addition reaction,

C) 1 to 30 wt. % of one or more hydrophilizing agents,

D) optionally further crosslinking substances and

E) optionally conventional additives,

with the proviso that component I) has been prepared either by a direct dispersing process or by the phase inversion process by means of a dispersing device with a high dispersing output per unit volume and has an average particle size of the dispersed particles of 0.05 to 10 μm, preferably 0.1 to 5 μm, in particular 0.15 to 2.5 μm, and particularly preferably 0.2 to 1.5 μm particle diameter.

Dispersing devices with a high dispersing output per unit volume, such as e.g. pressure release homogenizing jets, are used for the preparation of the dispersions I) essential to the invention by dispersing processes.

Corresponding dispersing machines are known e.g. from Formation of Emulsions, in P. Beche, Encyclopaedia of Emulsion Technology, vol. 1, New York, Basle, Decker 1983, but have not hitherto been employed for the preparation of such aqueous dispersions for aqueous stoving filler compositions.

Dispersing machines are chosen according to the output per unit volume. For the preparation of finely divided dispersions (approx. 1 μm particle diameter), dispersing machines with high outputs per unit volume are required, e.g. high-pressure homogenizers. Such finely divided dispersions can no longer be prepared well with rotor/stator machines. The jet disperser described in EP-A 0 101 007 is a specific pressure release jet which has a substantially higher efficiency than high-pressure homogenizers. Particle size distributions for which 200 bar are required in the high-pressure homogenizer are already achieved under a homogenizing pressure of 50 bar with the jet disperser.

Finely divided dispersions can be prepared particularly advantageously, both continuously and discontinuously, with the jet disperser as the dispersing device.

According to the invention, the aqueous dispersion can also be converted from a water-in-oil emulsion into an oil-in-water emulsion by phase inversion.

The aqueous dispersions I) which are prepared according to the invention and are essential to the invention can be used in combination with components II), III) and optionally IV) for stoving lacquering on any desired heat-resistant substrates, e.g. as filler compositions or base or top lacquers for the production of single-layer and/or multi-layer lacquerings, for example in the motor vehicle sector. The preferred use is in the filler composition sector.

Component A) of the dispersion I) which is essential to the invention comprises aliphatic and/or cycloaliphatic polyisocyanates containing biuret, isocyanurate, urethane, uretdione, allophanate and/or iminooxadiazinedione groups. Any desired mixtures of different polyisocyanates and polyisocyanates which contain several of the groupings mentioned can also be employed. The known aliphatic and/or cycloaliphatic diisocyanates from which the polyisocyanates are prepared by known processes, such as e.g. trimerization, allophanation, urethanization or biuretization, can be employed for the preparation of the polyisocyanates. Compounds which are preferably used are 1,6-diisocyanatohexane (HDI), 1-isocyanato-3,3,5-trimethyl-5-isocyanatomethylcyclohexane (isophorone-diisocyanate, IPDI), 2,4- and/or 2,6-diisocyanato-1-methylcyclohexane and 4,4′-diisocyanatodicyclohexylmethane (®Desmodur W, Bayer AG). Polyisocyanates containing isocyanurate, biuret and/or urethane groups and based on 1,6-diisocyanatohexane, isophorone-diisocyanate and ®Desmodur W are preferably employed.

The known monofunctional blocking agents, such as e.g. malonic acid esters, aceto-acetic acid esters, lactams, oximes, pyrazoles, triazoles, imidazoles, amines or any desired mixtures of these classes of compounds, can be employed as the blocking agent B). Blocking agents which split off in the temperature range up to 180° C., in particular up to 160° C., are preferably employed. Butanone oxime, cyclohexanone oxime and/or 3,5-dimethylpyrazole are preferred.

Internal emulsifiers, external emulsifiers or any desired mixtures of these compounds are used as the hydrophilizing agent C).

Nonionically hydrophilic builder components containing ethylene oxide units and/or (potentially) anionic builder components containing carboxyl groups are used as internal emulsifiers.

The nonionically hydrophilic builder components are compounds which contain one or two groups which are reactive towards isocyanate groups, in particular hydroxyl groups, per molecule. The polyether chains of these compounds comprise ethylene oxide units to the extent of at least 50 wt. %, preferably to the extent of 100 wt. %, it also being possible for propylene oxide units to be present in addition to these, according to the statements made. Suitable such nonionically hydrophilic builder components are, for example, monofunctional polyethylene glycol monoalkyl ethers with molecular weights of 350 to 3,000. The molecular weight is preferably between 500 and 1,000.

Compounds with at least one group which is reactive towards isocyanate groups are used as (potentially) anionic builder components. These compounds are preferably carboxylic acids containing at least one, preferably one or two hydroxyl groups, or salts of such hydroxycarboxylic acids. Suitable such acids are, for example, 2,2-bis(hydroxymethyl)alkanecarboxylic acids, such as dimethylolacetic acid, 2,2-dimethylolpropionic acid, 2,2-dimethylolbutyric acid or 2,2-dimethylolpentanoic acid, dihydroxysuccinic acid, hydroxypivalic acid or mixtures of such acids. Di-methylolpropionic acid and/or hydroxypivalic acid are particularly preferably used. The free acid groups, in particular carboxyl groups, are the abovementioned “potentially anionic” groups, while the salt-like groups obtained by neutralization with bases, in particular carboxylate groups, are the “anionic” groups referred to above. For the dissolving or dispersing in water, at least partial neutralization of the carboxyl groups is necessary. In general, the carboxyl groups are neutralized to the extent of at least 50%, it also optionally being possible to employ an excess of neutralizing agent.

Conventional emulsifiers and dispersing agents such as are described e.g. by Johann Bielmann in Lackadditive [Lacquer Additives], WILEY-VCH Verlag GmbH Weinheim, N.Y., Chichester, Brisbane, Singapore, Toronto 1998, pages 87-92, are used as external emulsifiers. Particularly suitable substances are, for example, addition products of ethylene oxide and optionally propylene oxide on hydrophobic starter molecules, such as e.g. nonylphenol, phenol/styrene condensates and long-chain, optionally branched alcohols, such as lauryl alcohol or stearyl alcohol. Ionic compounds of this type, such as, for example, sulfuric or phosphoric acid ester salts containing ethylene oxide and optionally propylene oxide units, such as are described e.g. in WO 97/31960, are also suitable.

The additional crosslinking component D) optionally employed comprises substances which lead to curing of the coatings according to the invention by chemical reaction with the hydroxyl groups of component II). Examples which may be mentioned are aminoplast resins, e.g. corresponding melamine derivatives, such as alkoxylated melamine resins or melamine-formaldehyde condensation products (e.g. FR-A 943 411, “The Chemistry of Organic Filmformers”, pages 235- 240, John Wiley & Sons Inc., New York 1974), and conventional crosslinking agents, e.g. epoxides, carboxylic acid anhydrides, phenoplasts resins, resol resins, urea resins or guanidine resins or mixtures thereof which are reactive with alcoholic hydroxyl groups.

The conventional additives E) optionally used are, for example, neutralizing agents, catalysts, auxiliary substances and/or additives, such as e.g. wetting agents, degassing agents, anti-sedimentation agents, flow agents, agents for trapping free radicals, antioxidants, UV absorbers, thickeners, small contents of solvents and biocides.

The dispersion I) essential to the invention is prepared in several stages, the ratios of amounts of the reaction partners being chosen such that the equivalent ratio of isocyanate groups of component A) to groups of component B) and optionally C) which are reactive towards isocyanate groups is 1:0.5 to 1:2, preferably 1:0.8 to 1:1.2, and particularly preferably 1:0.9 to 1:1.

If internal emulsifiers are used as component C), hydroxyl groups which are reactive towards isocyanate groups are present. In this case, for the preparation of the dispersion I) essential to the invention the ratios of amounts of the reaction partners are chosen such that an equivalent ratio of isocyanate groups of component A) to groups of components B) and C) which are reactive towards isocyanate groups is 1:0.5 to 1:2, preferably 1:0.8 to 1:1.2, and particularly preferably 1:0.9 to 1:1.

If nonionically hydrophilic builder components are used, the amount of component C) is such that 0.1 to 10 wt. %, preferably 0.5 to 5 wt. % of ethylene oxide units (calculated as C₂H₄O, molecular weight=44) incorporated within polyether chains in terminal and/or lateral positions are present in the resulting dispersion I) essential to the invention.

If (potentially) anionic builder components are used, component C) is employed in an amount such that 0.1 to 5 wt. %, preferably 0.5 to 1.5 wt. % of chemically fixed carboxyl groups (calculated as COOH, molecular weight=45) are present in the resulting dispersion I) essential to the invention.

If external emulsifiers are used as component C), no groups which are reactive towards isocyanate groups are present. In this case, the ratios of amounts of the reaction partners are chosen such that the equivalent ratio of isocyanate groups of component A) to groups of components B) which are reactive towards isocyanate groups is 1:0.8 to 1:1.2, preferably 1:0.9 to 1:1. The amount of external emulsifiers C) employed, based on the total amount of components A), B) and C), is 1 to 10 wt. %, preferably 3 to 7 wt. %, and particularly preferably 4 to 6 wt. %.

To prepare component I), the polyisocyanate A) is reacted in any desired sequence or simultaneously with the blocking agent B) and optionally an internal hydrophilizing agent C) in the abovementioned NCO/OH equivalent ratio. If no internal hydrophilizing agent is used, an external emulsifier C) is admixed in the abovementioned ratio of amounts before, during or after the reaction of components A) and B) in the abovementioned NCO/OH equivalent ratio.

The reactions are as a rule carried out in a temperature range from 20 to 140° C., preferably at 70 to 120° C., the reaction with (potentially) anionic builder components C) in particular being carried out under mild conditions to prevent the carboxyl group from also reacting with the isocyanate groups.

The reactions can be carried out without a solvent or in an inert solvent. The reaction in those inert solvents which can be removed completely or partly from the aqueous phase of a dispersion by vacuum distillation after the emulsifying step is preferred. Examples which may be mentioned are ketones, such as acetone and methyl ethyl ketone, and esters, such as ethyl acetate and butyl acetate, and aromatics, such as toluene and xylene. The reaction in methyl ethyl ketone is particularly preferred.

When the reaction has ended, at least partial neutralization of the carboxyl groups incorporated is carried out if a hydrophilization with a (potentially) anionic builder component C) has taken place. The addition of the neutralizing agent required for this can take place before, during or after the dispersing step. Bases which are suitable for this are ammonia, amines, such as e.g. N-methylmorpholine, dimethyliso-propanolamine, triethylamine, N,N-dimethylethanolamine, methyldiethanolamine, triethanolamine, morpholine, tripropylamine, triisopropylamine and 2-diethylamino-2-methyl-1-propanol, and mixtures of these and other neutralizing agents. Alkali metal or alkaline earth metal hydroxides, such as e.g. sodium hydroxide, lithium hydroxide or potassium hydroxide, are also suitable but less preferred as neutralizing agents. N,N-Dimethylethanolamine is the preferred neutralizing agents.

To prepare the aqueous suspension, the organic solution of the reaction product from components A), B) and optionally C) is mixed with water. This is effected either by the direct dispersing process, in which case the organic phase is dispersed in the aqueous phase, or by the phase inversion process, in which case a water-in-oil emulsion initially present is converted into an oil-in-water emulsion. This is carried out with the aid of a dispersing device with a high dispersing output per unit volume. Such devices can be e.g. cage stirrers, dissolvers, rotor/stator mixers or pressure release jets, preferably jet dispersers, the dispersing output per unit volume for the dispersing process being 1 to 10⁸ W/cm³, preferably 1 to 5·10⁷ W/cm³, and particularly preferably 1 to 3·10⁷ W/cm³. The average particle size of the particles of the aqueous dispersion or suspension is 0.05 to 10 μm, preferably 0.1 to 5 μm, in particular 0.15 to 2.5 μm, and particularly preferably 0.2 to 1.5 μm. To obtain specific particle size distributions it is appropriate to carry out the dispersing in several stages at a defined output per unit volume.

Before the dispersing operation by the jet disperser, it has proved advantageous first to prepare a pre-emulsion by means of a stirrer or dissolver and then to feed this pre-emulsion to the jet disperser. An amount of water is used in the preparation of the dispersions or emulsions such that 20 to 75 wt. %, preferably 30 to 70 wt. %, and particularly preferably 35 to 70 wt. % dispersions or emulsions of the binders I) essential to the invention result. When the addition of water has ended, the solvent is removed by distillation, preferably in vacuo.

The dispersing can be carried out in a wide temperature range, both at a low temperature, such as e.g. 10° C., and at a high temperature up to significantly above the melting point of the polymer mixture, such as e.g. 150° C. At such high temperatures only brief exposure to heat in the range of seconds is possible because of the reactivity of the binder systems.

The further crosslinking substances D) optionally employed and the conventional additives E) can be added to the organic solution of the reaction product of components A), B) and optionally C) before the dispersing operation. In the case of water-soluble or dispersible substances D) and E), these can also be added to the aqueous phase after the dispersing and distillation.

The polyhydroxy component II) comprises, for example, water-soluble or -dispersible polyhydroxy compounds of a number-average molecular weight Mn, which can be determined by gel permeation chromatography (polystyrene standard) of, 1,000 to 100,000, preferably 2,000 to 50,000, of the type known per se from the chemistry of polyurethane lacquers, provided that the polyhydroxy compounds have a content of hydrophilic groupings, in particular polyether chains containing carboxylate groups and/or ethylene oxide units, sufficient for their solubility or dispersibility in water. However, the use of hydrophilic polyhydroxy compounds which are not sufficiently hydrophilic by themselves as a mixture with external emulsifiers is in principle also possible.

Polyhydroxypolyesters, polyhydroxypolyethers, polyhydroxypolyurethanes, polyhydroxycarbonates, urethane-modified polyester polyols, urethane-modified polyether polyols, urethane-modified polycarbonate polyols or polymers containing hydroxyl groups, i.e. the polyhydroxypolyacrylates known per se, are possible as component II). However, mixtures of these polyhydroxy compounds mentioned or optionally grafted representatives of combinations of these polyhydroxy compounds prepared in situ, such as e.g. polyester-polyacrylate polyols, polyether-polyacrylate polyols, polyurethane-polyacrylate polyols, polyester-polyurethanes, polyether-polyurethanes, polycarbonate-polyurethanes and polyether-polyesters or mixtures thereof, can also be employed as component II).

The polyacrylate polyols are copolymers known per se of simple esters of acrylic and/or methacrylic acid, hydroxyalkyl esters, such as, for example, the 2-hydroxy-ethyl, 2-hydroxypropyl or 2-, 3- or 4-hydroxybutyl esters, of these acids being co-used for the purpose of introducing the hydroxyl groups. Acrylic and/or methacrylic acid e.g. are suitable for introducing carboxyl groups which can be neutralized with amines for the purpose of conversion into carboxylate groups. Possible further comonomers are olefinically unsaturated compounds, such as e.g. vinylaromatics, acrylonitrile, maleic acid di(cyclo)alkyl esters, vinyl esters, vinyl ethers etc.

The polymers can on the one hand be prepared directly in water with the aid of emulsifiers, in which case emulsion copolymers, which are also called “primary dispersions” are formed. On the other hand, preparation in organic solvents, and, after introduction of ionic groups, subsequent conversion into the aqueous phase is also possible, in which case so-called “secondary dispersions” are obtained.

Suitable polyether polyols are the ethoxylation and/or propoxylation products, which are known per se from polyurethane chemistry, of suitable 2- to 6-functional starter molecules, such as e.g. water, ethylene glycol, propanediol, trimethylolpropane, glycerol, pentaerythritol and/or sorbitol.

Examples of suitable polyester polyols are, in particular, the reaction products, which are known per se in polyurethane chemistry, of polyhydric alcohols, for example of alkane polyols of the type just mentioned by way of example with deficits of polycarboxylic acids or polycarboxylic acid anhydrides, in particular dicarboxylic acids or dicarboxylic acid anhydrides. Suitable polycarboxylic acids or polycarboxylic acid anhydrides are, for example, adipic acid, phthalic acid, isophthalic acid, phthalic anhydride, tetrahydrophthalic anhydride, hexahydrophthalic anhydride, maleic acid, maleic anhydride, Diels-Alder adducts thereof with cyclopentadiene, fumaric acid or dimeric or trimeric fatty acids. In order to establish specific molecular weights or functionalities of the polyester polyols, there is also the possibility of using monofunctional alcohols, such as e.g. 2-ethylhexanol or cyclohexanol, and/or monofunctional carboxylic acids, such as e.g. 2-ethylhexanoic acid, benzoic acid or cyclohexanecarboxylic acid. Any desired mixtures of mono- and polyfunctional alcohols or any desired mixture of mono- and polyfunctional carboxylic acids or carboxylic acid anhydrides can of course also be employed in the preparation of the polyester polyols.

The polyester polyols are prepared by known methods, such as are described e.g. in Houben-Weyl, Methoden der organischen Chemie [Methods of Organic Chemistry], volume XIV/2, G. Thieme-Verlag, Stuttgart, 1963, pages 1 to 47.

The hydrophilic modification of these polyester polyols optionally required is carried out by methods known per se, such as are disclosed, for example, in EP-A 0 157 291 or EP-A 0 427 028. The water-soluble or -dispersible urethane-modified polyesters described in these publications are particularly suitable according to the invention as component II). Urethane-modified polyester resins such as are described in DE-A 42 21 924 are particularly preferably possible as component II). The water-soluble or -dispersible polyacrylates containing hydroxyl groups described in DE-A 38 29 587 are also suitable, but less preferred.

Possible polyfunctional crosslinking resins III) are both water-soluble or -dispersible blocked polyisocyanates and water-soluble or -dispersible amino resins, such as e.g. melamine and urea resins. The water-soluble or -dispersible polyisocyanates such as have also already been mentioned beforehand in the prior art are in principle suitable. However, the water-soluble or -dispersible blocked polyisocyanates which are described in DE-A 42 21 924 and DE-A 198 10 660 are particularly suitable.

It is also possible to use already finished mixtures of representatives of components II) and E) as combination partners for the component I) essential to the invention. Such finished mixtures are already employed in practice because of their good storage stability at room temperature.

Further water-dispersible substances IV) which can be used are, for example, epoxy resins, phenolic resins, polyamine resins, low molecular weight epoxy crosslinking agents and low molecular weight polyamine crosslinking agents.

To prepare ready-to-use coating compositions, in particular filler compositions, the specific dispersions I) essential to the invention are mixed with the polyhydroxy compounds II), optionally the crosslinking agents III) and optionally representatives of component IV). The mixing ratio in respect of components I) to III) is in the range from 50:45:5 to 5:45:50 wt. %, preferably 45:45:10 to 10:45:45 wt. %, and particularly preferably 40:45:15 to 15:45:40 wt. %, based on the solid. Representatives of component IV) can optionally be employed in amounts of up to 20 wt. %, preferably 10 wt. %, based on the solid. Particularly preferably, only mixtures of components I) and II) and optionally III) are employed. The one-component binders obtained in this way can in general be stored for any desired length of time. Auxiliary substances and additives of coating technology which are optionally to be co-used, such as, for example, pigments, fillers, flow agents, wetting and dispersing agents, bubble-preventing agents, catalysts and the like, can be added to the aqueous binder or binder mixture and/or the individual components I), II) and optionally III) and IV). It is of particular advantage to process the individual components I), II) and optionally III) and IV) or I) and the mixture of II) and optionally III) with auxiliary substances, pigments and fillers to give ready-to-use pastes, which can then be mixed with one another as desired within the abovementioned limits. Quite specific properties for specific requirements can be achieved in this manner. There is also the possibility of already adding some additives, such as e.g. flow agents or catalysts, to component I) before dispersion thereof in water.

The one-component coating compositions comprising the dispersions I) essential to the invention can be applied by any desired methods of all of those in coating technology, such as e.g. spraying, brushing, dipping, flooding with the aid of rollers and doctor blades, to any desired heat-resistant substrates in one or several layers.

For example, coatings are obtained on metal, plastic, wood or glass by curing the lacquer film at 80 to 220° C., preferably 100 to 200° C., and particularly preferably 120 to 180° C.

The binders according to the invention are preferably suitable for the production of coatings and lacquerings on steel sheets, such as are used, for example, for the production of vehicle bodies, machines, panelling, drums or containers. They are preferably used for the preparation of car filler compositions. The lacquer films in general have a dry layer thickness of 0.01 to 0.3 mm.

The binders according to the invention give a long-lasting surface protection, as is demonstrated in the examples. The surprisingly high resistance to flying stones with a simultaneously high film hardness, which are contradictory properties per se, is to be singled out in particular. This makes the binders outstandingly suitable for applications where a good protection against flying stones coupled with a high lacquer film hardness is required.

The particular advantage of the new aqueous binders, in addition to their high stability during storage both at room temperature and at slightly elevated temperatures of 30 to 60° C., is the particularly high solids content of ≧55 wt. % which is to be achieved, which as a general rule is not achieved by the aqueous binders known to date.

The following examples illustrate the invention, but without limiting it.

### EXAMPLES

All the percentage data relate to the weight, unless noted otherwise.

### Example 1

### Preparation and Description of the Starting Substances

1.1. Polyisocyanate Component A1

1,332 g isophorone-diisocyanate (IPDI) are initially introduced under nitrogen into a 2 1 four-necked flask with a stirrer, gas inlet tube, inner thermometer, dropping funnel and reflux condenser and are heated to 80° C. 15 ml of a 5 wt. % solution of 2-hydroxypropyltrimethylammonium hydroxide in 2-ethyl-1,3-hexanediol/methanol (6:1, parts by wt.) are slowly and uniformly added dropwise from a dropping funnel in the course of 45 minutes. During this procedure the temperature rises to 88° C. (90° C. should not be exceeded because the trimerization proceeds non-specifically at too high temperatures and leads to higher viscosities of the end product). After the dropwise addition has ended, the reaction mixture is stirred at 80° C. until it has reached an NCO content of 30.6%. The reaction is then stopped by addition of 0.36 g (70 ppm molar) of a 25% solution of dibutyl phosphate in IPDI. Excess monomeric IPDI is removed by thin film distillation. A virtually colourless, clear resin is obtained with a yield of 44% and is dissolved 70% in methyl ethyl ketone. The viscosity of the solution at 23° C. is 300 mPa.s, the isocyanate content is 11.8% and the content of free monomeric IPDI is 0.18%.

1.2. Polyisocyanate Component A2

®Desmodur N 3300 (Bayer AG), solids content: 100%; viscosity at 23° C.; 3,500 mPa.s; isocyanate content: 21.8%.

### Example 2

### Preparation of the Dispersions I) Essential to the Invention

2.1. Dispersion I.1

355.93 g polyisocyanate component A1) are initially introduced into a 1 l four-necked flask with a stirrer, internal thermometer and reflux condenser, and are dissolved in 411.15 g methyl ethyl ketone and the solution is heated to 60° C. Thereafter, 96.13 g 3,5-dimethylpyrazole are added in portions, while stirring. The reaction mixture is stirred at 60° C. until the isocyanate band is no longer to be seen in the IR spectrum. 11.51 g Emulsifier WN (emulsifying auxiliary, Bayer AG) and 5.18 g ®Synperonic PE/F 127 (emulsifying auxiliary, ICI) are then added and a homogeneous mixture of the components is prepared by stirring. A water-in-oil emulsion is prepared from this solution by intensive mixing with 359.67 g water by means of a dissolver, and then undergoes a phase inversion into an oil-in-water emulsion by passage through a jet disperser under increased pressure (10 bar) in accordance with EP 0101007. The methyl ethyl ketone is distilled off in vacuo. The dispersion is then filtered through a filter of mesh width 10 μm. A product with the following characteristic data results:

| | |
|---|---|
| Flow time (ISO 4 cup, 23° C.): | 10 s |
| Solids content: | 50.3 wt. % |
| Average particle size: | 0.42 μm |
| (laser correlation spectroscopy) | |
| Blocked NCO content: | 11.64% |
| (calculated, based on the solids) | |

2.2. Dispersion I.2

192.66 g polyisocyanate component A2) are initially introduced into a 1 l four-necked flask with a stirrer, internal thermometer and reflux condenser, and are dissolved in 419.67 g methyl ethyl ketone and the solution is heated to 60° C. Thereafter, 87.12 g butanone oxime are added in portions, while stirring. The reaction mixture is stirred at 60° C. until the isocyanate band is no longer to be seen in the IR spectrum. 14.90 g Rhodafac PA 17 (emulsifying auxiliary, Rhodia) and 1.20 g of the neutralizing agent triethylamine are then added and a homogeneous mixture of the components is prepared by stirring. A water-in-oil emulsion is prepared from this solution by intensive mixing with 195.25 g water by means of a dissolver, and then undergoes a phase inversion into an oil-in-water emulsion by passage through a jet disperser under increased pressure (1 bar) in accordance with EP 0101007. The methyl ethyl ketone is distilled off in vacuo. The dispersion is then filtered through a filter of mesh width 10 μm. A product with the following characteristic data results:

| | |
|---|---|
| Flow time (ISO 4 cup, 23° C.): | 23 s |
| Solids content: | 60.0 wt. % |
| Average particle size: | 0.36 μm |
| (laser correlation spectroscopy) | |
| Blocked NCO content: | 14.25% |
| (calculated, based on the solids) | |

2.3. Dispersion I.3

177.96 g polyisocyanate component A1) and 96.33 g polyisocyanate component A2) are initially introduced into a 1 l four-necked flask with a stirrer, internal thermometer and reflux condenser, and are dissolved in 447.72 g methyl ethyl ketone and the solution is heated to 50° C. Thereafter, 113.16 g cyclohexanone oxime are added in portions, while stirring. The reaction mixture-is stirred at 50° C. until the isocyanate band is no longer to be seen in the IR spectrum. 17.70 g Rhodafac PA 17 (emulsifying auxiliary, Rhodia) and 1.67 g of the neutralizing agent N,N-dimethylethanol-amine are then added and a homogeneous mixture of the components is prepared by stirring. A water-in-oil emulsion is prepared from this solution by intensive mixing with 350.10 g water by means of a dissolver, and then undergoes a phase inversion into an oil-in-water emulsion by passage through a jet disperser under increased pressure (4 bar) in accordance with EP 0101007. The methyl ethyl ketone is distilled off in vacuo. The dispersion is then filtered through a filter of mesh width 10 μm. A product with the following characteristic data results:

| | |
|---|---|
| Flow time (ISO 4 cup, 23° C.): | 14 s |
| Solids content: | 49.6 wt. % |
| Average particle size: | 0.36 μm |
| (laser correlation spectroscopy) | |
| Blocked NCO content: | 14.25% |
| (calculated, based on the solids) | |

### Example 3

### Preparation of Base Pastes

The preparation of base pastes such as are conventionally used in practice is described.

3.1. Base Paste Based on a Self-Crosslinking Polyurethane Dispersion (®Bayhydrol VP LS 2153, Bayer AG), Comprising a Polyhydroxy Compound Dispersed in Water and a Blocked Polyisocyanate Dispersed in Water (Not According to the Invention)

For grinding for 30 minutes in a bead mill, the following components are weighed and predispersed for approx. 10 minutes by means of a dissolver: 667.7 parts by wt. of the 40% self-crosslinking PU dispersion Bayhydrol VP LS 2153;4.8 parts by wt. of a commercially available anti-cratering agent, 4.8 parts by wt. of a commercially available wetting agent; 4.1 parts by wt. of a conventional anti-sedimentation agent in the lacquer industry; 10.8 parts by wt. of a conventional defoamer for aqueous systems; 118.8 parts by wt. titanium dioxide; 1.3 parts by wt. iron oxide black; 119.7 parts by wt. micronized barite; 29.2 parts by wt. carbonate-free talc and 38.8 parts by wt. distilled water. This results in a paste with a solids content of approx. 53.6 wt. %.

3.2. Base Paste Based on the Dispersion I.2) Essential to the Invention in Combination with an Aqueous Polyhydroxy Component II) (Bayhydrol® VP LS 2056, Bayer AG) (According to the Invention)

The following components are weighed, predispersed for approx. 10 minutes by means of a dissolver and then ground for 30 minutes in a cooled bead mill: 387.9 parts by wt. of the 47% dispersion of the polyhydroxy compound Bayhydrol VP LS 2056; 237.8 parts by wt. of the 60% dispersion I.2); 5.9 parts by wt. of a commercially available anti-cratering agent; 5.9 parts by wt. of a commercially available wetting agent; 4.9 parts by wt. of a conventional anti-sedimentation agent in the lacquer industry; 13.0 parts by wt. of a conventional defoamer for aqueous systems; 143.6 parts by wt. titanium dioxide; 1.6 parts by wt. iron oxide black; 144.7 parts by wt. micronized barite; 35.3 parts by wt. carbonate-free talc and 19.4 parts by wt. distilled water. This results in a paste with a solids content of approx. 65.0 wt. %.

3.3. Base Paste Based on the Dispersion I.3) Essential to the Invention in Combination with an Aqueous Polyhydroxy Component II) (Bayhydrol® VP LS 2056, Bayer AG) (According to the Invention)

The following components are weighed, predispersed for approx. 10 minutes by means of a dissolver and then ground for 30 minutes in a cooled bead mill: 339.9 parts by wt. of the 47% dispersion of the polyhydroxy compound Bayhydrol VP LS 2056; 315.3 parts by wt. of the 49.6% dispersion I.3); 5.7 parts by wt. of a commercially available anti-cratering agent; 5.7 parts by wt. of a commercially available wetting agent; 4.8 parts by wt. of a conventional anti-sedimentation agent in the lacquer industry; 12.6 parts by wt. of a conventional defoamer for aqueous systems; 139.6 parts by wt. titanium dioxide; 1.5 parts by wt. iron oxide black; 140.6 parts by wt. micronized barite and 34.3 parts by wt. carbonate-free talc. This results in a paste with a solids content of approx. 63.2 wt. %.

### Example 4

### Preparation of Aqueous Filler Compositions Based on Base Pastes 3.1 to 3.3.

The pastes are mixed homogeneously according to the ratios stated in the following table by dispersing for 10 minutes by means of a dissolver and, where appropriate, brought to a processing viscosity of ≦35 s (ISO cup 5 mm, ISO 2431) with water. The compositions and characteristic data of the aqueous filler compositions obtained are shown in the following table 1.

TABLE 1

| Filler composition | | | | | |
|---|---|---|---|---|---|
| example | 1¹⁾ | 2²⁾ | 3²⁾ | 4²⁾ | 5²⁾ |
| Paste 3.1; | 92.2 pt. | | | 52.1 pt. | 51.9 pt. |
| 53.6% SC* | by wt. | | | by wt. | by wt. |
| Paste 3.2; | | 98.2 pt. | | 43.0 pt. | |
| 65.0% SC* | | by wt. | | by wt. | |
| Paste 3.3; | | | 100 pt. | | 44.0 pt. |
| 63.2% SC* | | | by wt. | | by wt. |
| Dist. water | 7.1 pt. | 1.8 pt. | — | 4.9 pt. | 4.1 pt. |
| | by wt. | by wt. | | by wt. | by wt. |
| | 100 pt. | 100 pt. | 100 pt. | 100 pt. | 100 pt. |
| | by wt. | by wt. | by wt. | by wt. | by wt. |
| Solids content | 49.8% | 63.8% | 63.2% | 55.9% | 55.6% |
| Flow time, 23° C. | | | | | |
| ISO cup 5 mm | 34 s | 30 s | 18 s | 30 s | 35 s |
| Flow time, 23° C. | 26 s | 30 s | 20 s | 30 s | 31 s |
| after 14 d at 40° C. | | | | | |

*SC = solids content
¹⁾not according to the invention
²⁾according to the invention

The solids contents of filler compositions 2 to 5 according to the invention are significantly higher and their viscosity stability after storage at 40° C is better than in the case of the high-quality comparison filler composition 1.

The aqueous filler compositions 1 to 5 were applied by spraying with a commercially available flow cup gun with an air pressure of 5 bar at approx. 65% rel. humidity (23° C.) on to zinc-phosphated steel sheets coated with a cathodically deposited electrodip primer (approx. 20 μm).

Curing of the filler compositions was carried out, after evaporation in air at 23° C. for 10 minutes, in a circulating air oven initially at 70° C. for 10 min and then at 165° C. for 20 min. The dry film thickness was approx. 35 μm.

The properties of the filler compositions are shown in the following table 2.

TABLE 2

| Filler composition | | | | | |
|---|---|---|---|---|---|
| example | 1¹⁾ | 2²⁾ | 3²⁾ | 4²⁾ | 5²⁾ |
| Erichsen | 10.0 mm | 9.0 mm | 5.0 mm | 10.0 mm | 10.0 mm |
| indentation | | | | | |
| DIN ISO 1520 | | | | | |
| Pendulum | 75 s | 108 s | 136 s | 97 s | 121 s |
| hardness | | | | | |
| DIN 53157 | | | | | |
| Gloss 60° C. by | 64% | 73% | 77% | 65% | 70% |
| the Gardner | | | | | |
| method | | | | | |

Filler compositions 2 to 5 according to the invention have a very high hardness and an elasticity which is very good for this hardness, compared with the commercially available filler composition 1. The gloss values of the filler compositions 2 to 5 according to the invention are at a similar level to the gloss value of the commercially available filler composition 1.

A commercially available car top lacquer based on alkyd/melamine resin was applied to the filler composition layers by means of an air-atomizing spray gun with a dry film thickness of approx. 30 μm and was cured at 130° C. for 30 min.

The most important test results which are decisive for use of the filler compositions are summarized in the following table. The resistance values, which are not stated, such as e.g. resistance to solvents, water and salt spray, correspond entirely to the requirements in practice.

Test Methods Used

Top Lacquer Status

Measurement of the waviness by means of a Wave Scan measuring apparatus from Byk

Resistance to Flying Stones

The test apparatuses used were

a) Flying stone test apparatus according to VDA (Erichsen, model 508) with 500 g steel shot (angular, 4-5 mm) fired in each case twice with an air pressure of 1.5 bar at 23° C. Comparisons were made in respect of penetrations down to the sheet metal (0 to 10, 0=no penetrations, 10=very many penetrations).

b) Individual impact test apparatus ESP-10 according to BMW standard DBP no. 34.31.390 (Byk), the chips of the filler composition from the sheet metal are measured in mm.

Top Lacquer Status, Measurement by Means of the Wave Scan (Byk) (Corrected Values Stated)

| Filler composition example | 1¹⁾ | 2²⁾ | 3²⁾ | 4²⁾ | 5²⁾ |
|---|---|---|---|---|---|
| Short-waviness | 6.2 | 6.3 | 5.4 | 5.0 | 4.2 |
| Long-waviness | 29.3 | 26.7 | 25.3 | 23.1 | 19.3 |

The lower the numerical values both for the short- and for the long-waviness, the better the top lacquer status. Filler compositions 2 to 5 according to the invention accordingly lead to a better top lacquer status than comparison filler composition 1.

Flying Stones Test

500 mg steel shot twice, 1.5 bar (characteristic rating 1-10)

| Filler composition | | | | | |
|---|---|---|---|---|---|
| example | 1¹⁾ | 2²⁾ | 3² | 4²⁾ | 5²⁾ |
| VDA multi-impact: | 2 | 2 | 2 | 1-2 | 1-2 |
| Characteristic rating for | | | | | |
| penetrations | | | | | |
| BMW individual impact | <1 mm | 1.0 mm | 1.0 mm | <1 mm | <1 mm |
| at −20° C. | | | | | |

Filler compositions 4 to 5 according to the invention are at the same high level as the high-quality comparison filler composition 1, although the filler compositions according to the invention have a considerably higher hardness. This result is surprising and is therefore not foreseeable. Filler compositions 2 and 3 according to the invention have a slightly poorer resistance to flying stones.

Summary and Discussion of the Results

Filler compositions 2 to 5 according to the invention are distinguished by a very high solids content and a very high hardness. Only a low elasticity associated with a lack of resistance to flying stones and a poor top lacquer status were therefore to be expected. However, the test results clearly show that the filler compositions according to the invention, in contrast to the prior art to date, have both good elasticity values and very good resistances to flying stones and top lacquer status, and are therefore superior to a high-quality commercially available polyurethane filler composition. They have a hitherto unknown quality level in respect of the overall spectrum of properties.

1. Binder mixture for aqueous stoving lacquers comprising
I) specific blocked polyisocyanates dispersed in water,
II) water-soluble or -dispersible polyhydroxy compounds,
III) optionally water-soluble or -dispersible crosslinking resins and
IV) optionally further water-soluble or -dispersible substances,
characterized in that component I) comprises
A) 40 to 80 wt. % of one or more polyisocyanate components,
B) 10 to 40 wt. % of one or more blocking agents for isocyanate groups which are monofunctional in the sense of the isocyanate addition reaction,
C) 1 to 30 wt. % of one or more hydrophilizing agents,
D) optionally further crosslinking substances and
E) optionally conventional additives,
with the proviso that component I) has been prepared either by a direct dispersing process or by the phase inversion process by means of a dispersing device with a high dispersing output per unit volume and has an average particle size of the dispersed particles of 0.05 to 10 μm particle diameter.

2. Binder mixture according to claim 1, characterized in that aliphatic and/or cycloaliphatic polyisocyanates containing biuret, isocyanurate, urethane uretdione, allophanate and/or iminooxadiazinedione groups are employed as polyisocyanate components A) of component I).

3. Binder mixture according to claim 1, characterized in that oximes and/or pyrazoles are employed as the blocking agent B) of component I).

4. Binder mixture according to claim 1, characterized in that external emulsifiers are employed as the hydrophilizing agents C) of component I).

5. Binder mixture according to claim 1, characterized in that polyhydroxypolyesters, polyhydroxypolyethers, polyhydroxypolyurethanes, polyhydroxycarbonates, urethane-modified polyester polyols, urethane-modified polyether polyols, urethane-modified polycarbonate polyols, polymers containing hydroxyl groups, polyester-polyacrylate polyols, polyether-polyacrylate polyols, polyurethane-polyacrylate polyols, polyester-polyurethanes, polyether-polyurethanes, polycarbonate-polyurethanes, polyether-polyesters or mixtures thereof are employed as component II).

6. Binder mixture according to claim 1, characterized in that water-soluble or -dispersible blocked polyisocyanates are employed as component III).

7. Binder mixture according to claim 1, characterized in that water-soluble or -dispersible amino resins are employed as component III).

8. Use of the binder mixtures according to any of claims 1 to 7 for the preparation of aqueous stoving lacquers which optionally comprise the conventional auxiliary substances and additives of coating technology.

9. Use of the aqueous stoving lacquer according to claim 8 for the preparation of fillers for metal components.

10. Use of the aqueous stoving lacquer according to claim 8 for the preparation of filler compositions for car body components.
